(19) United States
(12) Patent Application Publication
(10) Pub. No.: US 2023/0160222 A1
(43) Pub. Date: May 25, 2023

(54) ROTARY MOVING 3D PRINTER

(71) Applicant: Shanghai Yannuo Building Material Co., Ltd., Shanghai (CN)

(72) Inventor: Yihe MA, Shanghai (CN)

(21) Appl. No.: 17/535,475

(22) Filed: Nov. 24, 2021

(51) Int. Cl. E04G 21/04; B33Y 30/00

(52) U.S. Cl. CPC E04G 21/0427; B33Y 30/00; E04B 1/16

(57) ABSTRACT

A rotary mobile 3D printer, with a printer; an upright post; and a cross arm. The printer is connected to the cross arm; the cross arm is rotatably connected to the upright post so that the cross arm is rotatable around the connection point where the cross arm is rotatably connected to the upright post; the printer is rotatable together with the cross arm; the printer is movable back and forth in a first direction and back and forth in a second direction relative to the cross arm; the first direction is the lengthwise direction of the cross arm; and the second direction extends at an angle with respect to the first direction.

### FIELD OF THE INVENTION

The present invention relates to the technical field of printing machinery, in particular to a printing device.

### BACKGROUND OF THE INVENTION

3D printing is a kind of rapid prototyping technology. Based on digital model files, special wax, powdered metal or plastic and other bondable materials are used to construct objects by layer-by-layer printing. With the rapid development of science and technology, 3D printing technology is also applied in more fields. A more recent development in 3D printing is creating buildings or other structures by 3D printing in the field of construction. However, at present, most 3D printers still have many shortcomings when printing, for example, the moving direction of 3D printers is limited, which not only affects printing efficiency, but also limits the printing range of printers.

In view of this, there is an urgent need for a printing device that can solve the above problems.

The information disclosed in this section of background of art is only intended to deepen the understanding of the general background art of the present invention, and should not be regarded as admitting or implying in any form that the information constitutes the prior art that is already known to those skilled in the art.

### SUMMARY OF THE INVENTION

According to an aspect of the invention, a rotary mobile 3D printer, is provided, comprising a printer; an upright post; and a cross arm. The printer is connected to the cross arm; the cross arm is rotatably connected to the upright post so that the cross arm is rotatable around the connection point where the cross arm is rotatably connected to the upright post; the printer is rotatable together with the cross arm; the printer is movable back and forth in a first direction and back and forth in a second direction relative to the cross arm; the first direction is the lengthwise direction of the cross arm; and the second direction extends at an angle with respect to the first direction.

### DETAILED DESCRIPTION OF THE INVENTION

The purpose of the present invention is to provide a printing device to alleviate the technical problems of low printing efficiency and small printing range caused by the limitation of 3D printer movement during printing in the prior art.

In order to achieve the above purpose, the present invention adopts the following technical scheme:

The present invention provides a printing device, which comprises a printer, an upright post and a cross arm.

The printer is connected to the cross arm, the cross arm is rotatably connected to the upright post, the cross arm can rotate around the connection point with the upright post, and the printer can rotate together with the cross arm. The printer can move back and forth in a first direction relative to the cross arm, and the printer can move back and forth in a second direction relative to the cross arm.

The first direction is the lengthwise direction of the cross arm, and the second direction extends at an angle with respect to the first direction for example at a right angle or any angle between 1 and 90 degrees.

In any of the above embodiments, the printing device further comprises a rotary mechanism, which is connected between the upright post and the cross arm, and is used to drive the cross arm to rotate relative to the upright post.

In any of the above embodiments, further, the rotary mechanism comprises a first driving member, a first gear and a second gear, wherein the first gear is installed on the cross arm and the second gear is installed on the upright post.

The power output end of the first driving member is in driving connection with the first gear, and the first gear meshes with the second gear, and the first gear can rotate around the axis of the second gear, and the cross arm moves synchronously with the first gear.

In any of the above embodiments, the printing device further comprises a translational moving mechanism, which is connected between the printer and the cross arm and is used to drive the printer to move in the first direction.

In any of the above embodiments, further, the cross arm is provided with a first rack with the length extending in the first direction.

The translational moving mechanism comprises a second driving member, a third gear and a mounting bracket for connecting the printer, wherein the mounting bracket is slidably connected to the cross arm, and the second driving member is mounted on the mounting bracket.

The power output end of the second driving member is in a driving connection with the third gear, and the third gear is meshing with a first rack.

In any of the above embodiments, further, the cross arm may be provided with a guide rail with a lengthwise extending portion thereof extending in the first direction, the mounting bracket is provided with a clamping groove, the clamping groove is in clamping connection with the guide rail, and the mounting bracket can slide in the lengthwise direction of the guide rail through the clamping groove.

In any of the above embodiments, the printing device further comprises a vertical arm. The printer is mounted on the vertical arm and the vertical arm is slidably connected to the mounting frame and can slide in the second direction. The printer moves together with the vertical arm.

In any of the above embodiments, further, the vertical arm may be provided with a second rack with a length extending in the second direction.

The printing device also includes a third driving member and a fourth gear in a driving connection with the power output end of the third driving member, and the third driving member is installed on the mounting bracket, and the fourth gear meshes with the second rack.

In any of the above embodiments, the printing device further comprises a counterweight component, the counterweight component is installed on the cross arm and can move back and forth in the first direction relative to the cross arm, and the upright post is located between the counterweight component and the printer.

In any of the above embodiments, further, the cross arm is provided with a third rack with the length extending in the first direction.

The counterweight component comprises a fourth driving member, a fifth gear and a counterweight block, wherein the counterweight block is slidably connected to the cross arm, and the fourth driving member is installed on the counterweight block.

The power output end of the fourth driving member is in a driving connection with the fifth gear, and the fifth gear meshes with the third rack.

In any of the above embodiments, the printing device further comprises a fixed base fixedly arranged on the upright post, and the fixed base is used for supporting the upright post.

The present invention has the beneficial effects as follows:

The present invention provides a printing device, which comprises a printer, an upright post and a horizontal arm, wherein the printer is connected to the horizontal arm, and the horizontal arm is rotatably connected to the upright post, so that the horizontal arm can rotate around the connection point with the upright post, thereby driving the printer to rotate together with the horizontal arm.

At the same time, the printer can move back and forth in the first direction relative to the cross arm, and also move back and forth in the second direction relative to the cross arm, and further, the printer can move in multiple directions, thereby improving the flexibility of using the printing device. At the same time, it is precisely because the printer is capable of moving in multiple directions that it can meet various printing requirements and improve printing efficiency.

In order to explain the embodiments of the present invention or the technical scheme in the prior art more clearly, the drawings that need to be used in the description of the embodiments or the prior art will be briefly described. Obviously, the drawings in the following description are some embodiments of the present invention, and for those skilled in the art, other drawings can be obtained according to these drawings.

### BRIEF DESCRIPTION OF THE DRAWINGS

FIG. 1 is a first partial schematic diagram of the printing device provided by an embodiment of the present invention.

FIG. 2 is a second partial schematic diagram of the printing device provided by an embodiment of the present invention.

FIG. 3 is a partial enlarged view at A in FIG. 2.

FIG. 4 is a partial enlarged view at B in FIG. 2.

FIG. 5 is a third partial schematic diagram of the printing device provided by an embodiment of the present invention.

FIG. 6 is a front view of the partial structure of the printing device provided by an embodiment of the present invention.

FIG. 7 is a partial enlarged view at C in FIG. 6.

FIG. 8 is a schematic diagram of the rotary mechanism in the printing device provided by an embodiment of the present invention.

FIG. 9 is a schematic diagram of the counterweight component in the printing device provided by an embodiment of the present invention.

### DETAILED DESCRIPTION OF THE DRAWINGS

In order to make clearer the purpose, technical scheme and advantages of the embodiments of the present invention, the technical scheme of the embodiments of the present invention will be described clearly and completely with reference to the drawings of the embodiments of the present invention. Obviously, the described embodiments are part of the embodiments of the present invention, but not all of them. Based on the embodiments of the present invention, all other embodiments obtained by those skilled in the art without creative work are within the scope of protection of the present invention.

In the description of the present invention, it should be noted that the terms “first” and “second” are only used for descriptive purposes, and cannot be understood as indicating or implying relative importance.

In the description of the embodiments of the present invention, it should be noted that the terms “installing”, “associating” and “connecting” should be understood in a broad sense. For example, they can be fixed connection, detachable connection or integrated connection; mechanical connection, or electric connection; direct connection or connection via an intermediate medium or internal communication of two elements. For those skilled in the art, the meaning of the above terms in the present invention can be understood in specific situations.

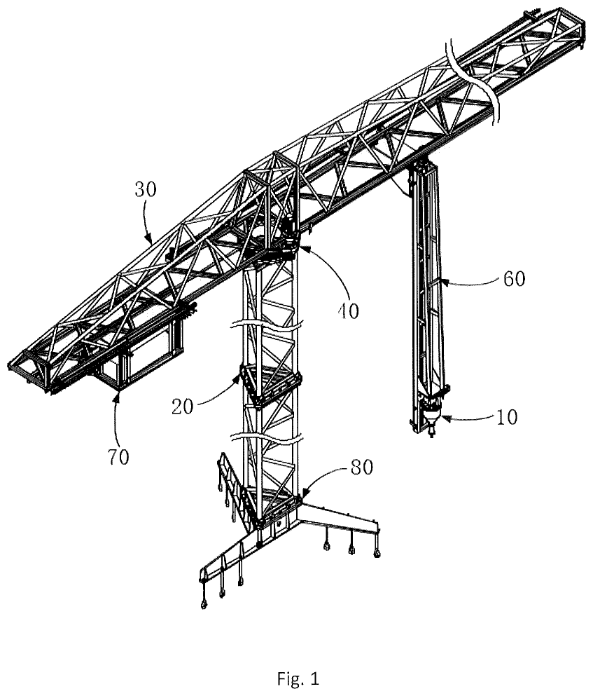

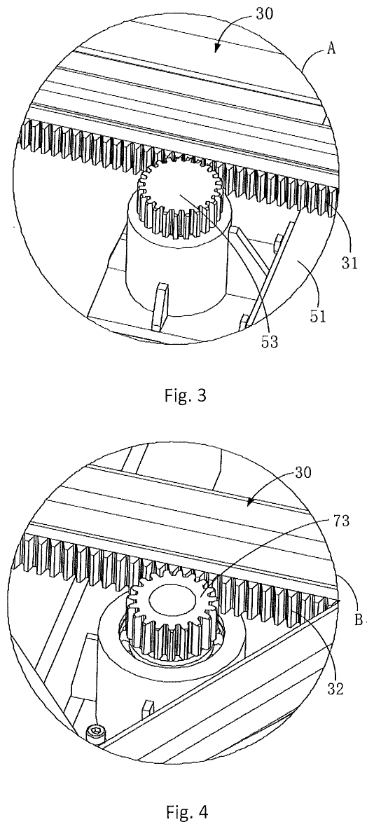

As shown in FIGS. 1-8, the printing device provided by this embodiment includes a printer 10, an upright post 20 and a cross arm 30. The printer 10 is connected to the cross arm 30 which is rotatably connected to the upright post 20. The cross arm 30 can rotate around the connection point with the upright post 20, and the printer 10 can rotate together with the cross arm 30. The printer 10 can move back and forth in a first direction relative to the cross arm 30, and the printer 10 can move back and forth in a second direction relative to the cross arm 30. The first direction is the lengthwise direction of the cross arm 30, and the second direction extends at an angle in relation to the first direction.

In this embodiment, the first direction is the lengthwise direction of the cross arm 30, and the second direction is the lengthwise direction of the upright post 20, and the first direction and the second direction are at a right angle to each other. If the length of the upright post 20 extends in the vertical direction, the length of the cross arm 30 extends in the horizontal direction.

The upright post is used to support the cross arm 30 and the cross arm 30 is rotationally connected with the upright post 20, so that the cross arm 30 can perform a rotational movement. The printer 10 is installed on the cross arm 30, which can drive the printer 10 to rotate synchronously when the cross arm 30 rotates relative to the upright post 20. If the connection point between the cross arm 30 and the upright post 20 is taken as the first point and the connection point between the printer 10 and the cross arm 30 as the second point, then the linear distance from the first point to the second point is the rotation radius of the printer 10 with the cross arm 30. At the same time, the printer 10 can move in the lengthwise direction of the cross arm 30 relative to the cross arm 30, so that the linear distance between the second point and the first point can be adjusted, that is, the rotation radius of the printer 10 can be adjusted. Moreover, the printer 10 can also move in the lengthwise direction of the upright post 20 relative to the cross arm 30, that is, the printer 10 can move up and down in the vertical direction to further adjusts its printing height.

Compared with the 3D printers in the prior art, which can only make simple translational movement, the printing device can match the translational movement with the rotation, so that the printer 10 can not only move up and down in the vertical direction, but also move in the horizontal direction, and at the same time, it can perform a rotational movement, thus increasing the flexibility of the printer 10 in operation to meet various printing requirements and improve printing efficiency.

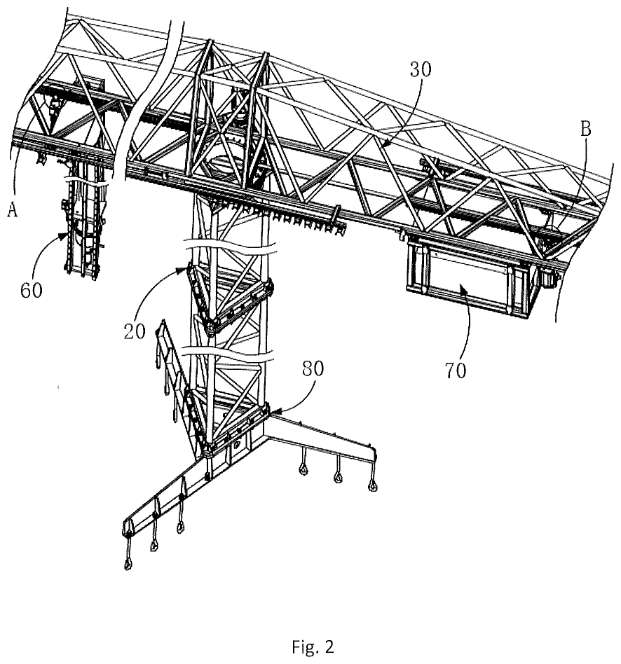

Referring to FIG. 1 and FIG. 2, in actual use, the printing device also includes a fixed base 80 fixedly arranged on the upright post 20, and the fixed base 80 is used for supporting the upright post 20.

Specifically, the fixed base 80 is fixed on the printing site to ensure the stability of the upright post 20 to support the rotating cross arm and the printer 10 installed thereon. In this embodiment, the fixed base 80 includes a base with a triangular structure and legs connected to three top points of the base, respectively, each leg extending with one edge of the base as a reference successively. Each leg is provided with a plurality of eyebolts to facilitate fixing relative to the printing site. At the same time, each leg is provided with reinforcing ribs to improve the structural stability of the leg and further improve the supporting performance to the upright post 20. The base uses the principle of high triangular stability to ensure good supporting performance. The cross section of the upright post 20 is also triangular, which adapts to the cross section of the base. The upright post 20 includes a connecting seat and a plurality of supporting joints, which are arranged spaced apart from the respective neighboring supporting joints in the vertical direction, and any two adjacent support joints are fixedly connected by the connecting seat. The support joints include vertical rods respectively located at the three vertices of the triangle and inclined rods connected among the three vertical rods, and both ends of each inclined rod are fixedly connected with one vertical rod respectively.

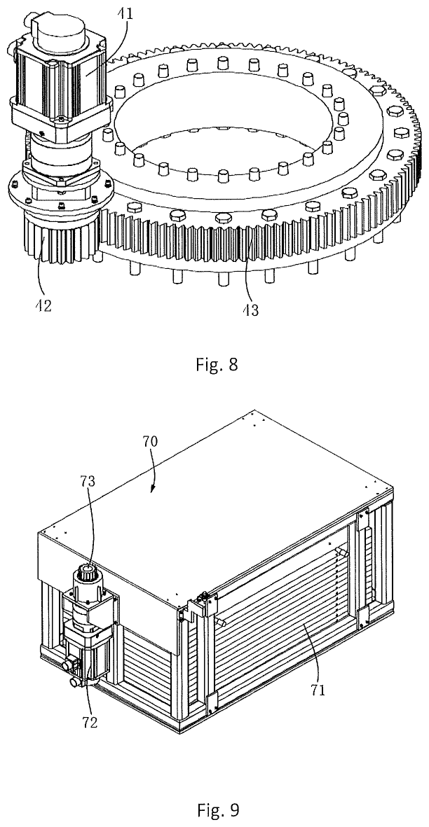

Referring to FIG. 1, FIG. 2 and FIG. 8, preferably, the printing device also includes a rotary mechanism 40, wherein the rotary mechanism 40 is connected between the upright post 20 and the cross arm 30, and the rotary mechanism 40 is used to drive the cross arm 30 to rotate relative to the upright post 20. Specifically, a first support base plate is arranged on the top of the upright post 20, and a second support base plate is arranged on the side of the cross arm 30 facing the upright post 20. The rotary mechanism 40 is installed between the first support base plate and the second support base plate. The first support base plate and the second support base plate are used to reduce the wear of the upright post 20 and the cross arm 30.

Referring to FIGS. 1, 2 and 8, in some embodiments, the rotary mechanism 40 includes a first driving member 41, a first gear 42 and a second gear 43, wherein the first gear 42 is installed on the cross arm 30 and the second gear 43 is installed on the upright post 20. The power output end of the first driving member 41 is in driving connection with the first gear 42, the first gear 42 meshes with the second gear 43, and the first gear 42 can rotate around the axis of the second gear 43, and the cross arm 30 moves synchronously with the first gear 42 as a consequence of being rotationally fixed with respect to the cross arm 30.

Specifically, the upright post 20 is connected to the middle of the cross arm 30, based on the connection point between the cross arm 30 and the upright post 20. The truss-like cross arm 30 tapers from its highest constructional dimension at the connection point towards the two extended ends of the cross arm 30, gradually changing from large at the connection point to small at the remote free ends of truss-like cross arm 30. The length of the cross arm 30 is much larger than the width of the cross arm 30, so that the printer 10 can move in the lengthwise direction of the cross arm 30 by a longer distance. One side along the width direction of the cross arm 30 is provided with a connection plate protruding from the cross arm 30. The first gear 42 is installed on the connecting plate, and the second gear 43 is installed on the first supporting base plate of the upright post 20. The first gear 42 rotates around its own axis under the power of the first driving member 41, and the first gear 42 is meshing with the second gear 43 to facilitate the rotation of the first gear 42 around the axis of the second gear 43, that is, the first gear 42 rotates around the axis of the second gear 43 so that the first gear 42 drives the cross arm 30 to rotate with the first gear 42 to which it is attached, so that the cross arm 30 moves the printer 10 to rotate with the cross arm 30.

Referring to FIGS. 1-5, preferably, the printing device further includes a translational moving mechanism 50, which is connected between the printer 10 and the cross arm 30 and is used to drive the printer 10 to move in the first direction. That is, the translational moving mechanism 50 can drive the printer 10 to move in the lengthwise direction of the cross arm 30, thereby enabling the printer 10 to adjust not only its printing length but also its turning radius.

Referring to FIGS. 1-3, preferably, the cross arm 30 is provided with a first rack 31 with the length extending in the first direction. The translational moving mechanism 50 includes a second driving member 52, a third gear 53 and a mounting bracket 51 for connecting the printer 10. The mounting bracket 51 is slidably connected to the cross arm 30, and the second driving member 52 is mounted on the mounting bracket 51. The power output end of the second driving member 52 is in driving connection with the third gear 53, and the third gear 53 meshes with the first rack 31.

Specifically, the connecting point between the upright post 20 and the cross arm 30 divides the cross arm 30 into two sections, namely the first section and the second section used for connecting the printer 10. The first rack 31 is fixedly installed on the second section of the cross arm 30, and the first rack 31 extends in the lengthwise direction of the cross arm 30. The cross section of the mounting frame 51 in the vertical direction is of a right-angle trapezoidal structure, including a long side wall, a short side wall, two trapezoidal side walls and a right-angle side wall connected between the two trapezoidal side walls. The long side wall and the short side wall are opposite to each other and spaced apart from one another, and the two trapezoidal side walls are opposite to each other and spaced apart from one another, and the length of the right-angle side wall extends in the vertical direction. The long side wall is slidably connected with the cross arm 30. One trapezoidal side wall of the mounting frame 51 is provided with a first motor base, the second driving member 52 is mounted on the mounting frame 51 through the first motor base, and the second driving member 52 is in driving connection with the third gear 53 to drive the third gear 53 to rotate around its own axis, and the third gear 53 meshes with the first rack 31 to drive the mounting bracket 51 to slide in the lengthwise direction of the cross arm 30, so as to realize the translational movement of the printer 10 relative to the cross arm 30 through the mounting bracket 51.

In this embodiment, the cross arm 30 is provided with a first guide rail with a length extending in the first direction, and the mounting bracket 51 is provided with a first clamping groove which is in clamping connection with the first guide rail, and the mounting bracket 51 slides in the lengthwise direction of the first guide rail through the first clamping groove.

Specifically, the number of the first guide rails is two, and the two first guide rails are arranged at interval along the width direction of the cross arm 30. A first sliding block is fixed on the wall surface of the long side of the mounting frame 51 facing the cross arm 30. The first sliding block is provided with a first clamping groove, and the first guide rails can be inserted into the first clamping groove and slidably connected with the first sliding block. There are four first sliding blocks, with two first sliding blocks in a group, which are together connected with the same first guide rail to improve the stability of the connection between the mounting frame 51 and the cross arm 30. At the same time, the sliding between the first guide rail and the first slider improves the translational movement stability of the mounting frame 51 relative to the cross arm 30.

The cross arm 30 is also provided with a first proximity switch used to indicate the critical position of the movement of the mounting bracket 51 relative to the cross arm 30, thus further improving the safety of the movement of the mounting bracket 51 relative to the cross arm 30.

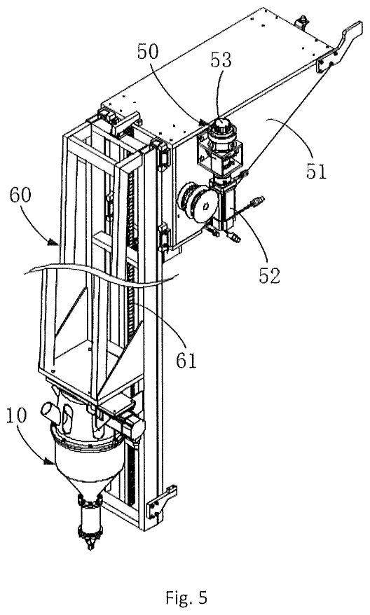

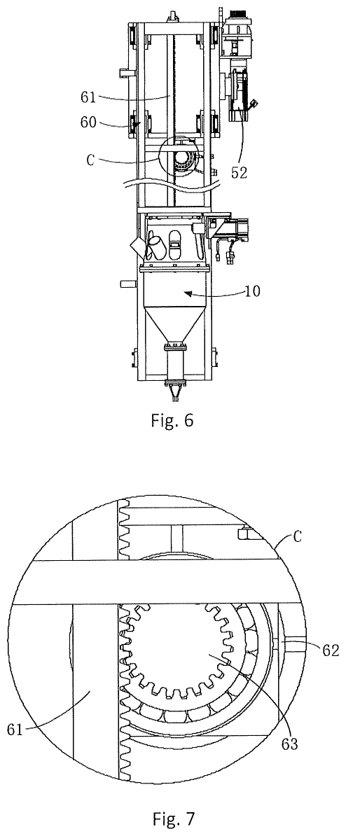

Referring to FIG. 1, FIG. 2, FIG. 5 and FIG. 6, preferably, the printing device further includes a vertical arm 60. The printer 10 is mounted on the vertical arm 60, the vertical arm 60 is slidably connected to the mounting bracket 51 and can slide in the second direction, and the printer 10 moves together with the vertical arm 60.

Specifically, a vertical arm 60 is connected to the right-angle side wall of the mounting bracket 51, and the length of the vertical arm 60 extends in the lengthwise direction of the upright post 20, that is, extends vertically, and the printer 10 is installed at the extension end of the vertical arm 60. The vertical arm 60 can move vertically relative to the mounting bracket 51, thereby driving the printer 10 to move synchronously, so as to change the height of the printer 10.

Referring to FIGS. 5-7. In this embodiment, the vertical arm 60 is provided with a second rack 61 extending in the second direction. The printing device also includes a third driving member 62 and a fourth gear 63 which is in driving connection with the power output end of the third driving member 62. The third driving member 62 is installed on the mounting bracket 51, and the fourth gear 63 meshes with the second rack 61. Specifically, the second rack 61 is fixedly arranged on the vertical arm 60 and extends in the lengthwise direction of the vertical arm 60.

The short side wall of the mounting frame 51 is provided with a second motor seat through which the third driving member 62 is installed on the mounting bracket 51, and the drive shaft of the third driving member 62 is in driving connection with the fourth gear 63, driving the fourth gear 63 to rotate around its own axis. At the same time, the fourth gear 63 meshes with the second rack 61, driving the vertical arm 60 to slide vertically relative to the mounting bracket 51, thus realizing the vertical movement of the printer 10.

Second sliding blocks are fixedly installed on the right-angle side wall of the mounting bracket 51, and the side of the vertical arm 60 facing the mounting bracket 51 is provided with second guide rails. Each second sliding block is provided with a second clamping groove in which the second guide rail can be inserted, and the second guide rail can slide relative to the second sliding block through the second clamping groove. The number of second guide rails is two, and the two second guide rails are arranged at intervals along the cross arm 30 in its lengthwise direction. There are four second sliding blocks, with two second sliding blocks in a group, which are together connected with the same second guide rail to further improve the sliding stability of the vertical arm 60 relative to the mounting frame 51.

The mounting bracket 51 is provided with a second proximity switch, which serves as the critical position for the vertical arm 60 to move relative to the mounting bracket 51, thus improving the safety between them and further improving the printing safety.

Referring to FIG. 1, FIG. 2, FIG. 4 and FIG. 9, preferably, the printing device further comprises a counterweight component 70, which is installed on the cross arm 30 and can move in the first direction relative to the cross arm 30, and the upright post 20 is located between the counterweight component 70 and the printer 10.

Specifically, the counterweight component 70 is installed on the first section of the cross arm 30, that is, the counterweight component 70 and the mounting bracket 51 are installed at two sections of the cross arm 30, respectively. The counterweight component 70 is used to ensure the stability and stationarity of the cross arm 30 when the printer 10 moves in the lengthwise direction of the cross arm 30 with the mounting bracket 51.

Referring to FIG. 2, FIG. 4 and FIG. 9, preferably, the cross arm 30 is provided with a third rack 32 with the length extending in the first direction. The counterweight component 70 includes a fourth driving member 72, a fifth gear 73 and a counterweight block 71. The counterweight block 71 is slidably connected to the cross arm 30, and the fourth driving member 72 is installed on the counterweight block 71. The power output end of the fourth driving member 72 is in driving connection with the fifth gear 73, and the fifth gear 73 meshes with the third rack 32.

Specifically, the third rack 32 is fixedly arranged on the cross arm 30 and can extend in the lengthwise direction of the cross arm 30. The counterweight block 71 includes a counterweight box and counterweight members installed in the counterweight box. The counterweight box is slidably connected to the cross arm 30, a third motor seat is fixedly arranged on one side wall of the counterweight box, and the fourth driving member 72 is installed in the counterweight box through the third motor seat. The drive shaft of the fourth driving member 72 is in driving connection with the fifth gear 73 to drive the fifth gear 73 to rotate around its own axis. At the same time, the fifth gear 73 meshes with the third rack 32, so that the counterweight box can move in the lengthwise direction of the cross arm 30 relative to the cross arm 30.

The cross arm 30 is connected with a third guide rail with the length extending in the lengthwise direction of the cross arm 30, the counterweight box is fixedly provided with a third sliding block, which is provided with a third clamping groove for clamping and matching with the third guide rail, and the third guide rail can slide relative to the third sliding block through the third clamping groove. At the same time, the number of the third guide rails is two, the number of the third sliding blocks is four, with two third sliding blocks in a group, and they are together connected with the same third guide rail to improve the connection reliability between the counterweight box and the cross arm 30.

In actual use, the printing device is also provided with a master control center, and the fourth driving member 72 and the second driving member 52 are electrically connected with the master control center. When the rotation radius of the printer 10 needs to be adjusted, the master control center controls the fourth driving member 72 and the second driving member 52 to start synchronously. If the printer 10 moves away from the upright post 20, the counterweight box also moves away from the upright post 20. If the printer 10 moves in the direction close to the upright post 20, the counterweight box also moves in the direction close to the upright post 20. No matter how the printer 10 and the counterweight box move, it is only necessary to ensure the horizontal balance of the cross arm 30.

The number of counterweight members in the counterweight box can be increased or decreased according to actual needs.

The first driving member 41, the second driving member 52, the third driving member 62 and the fourth driving member 72 are servo motors.

The linear movement of the mounting bracket 51 relative to the cross arm 30, the linear movement of the vertical arm 60 relative to the mounting bracket 51 and the linear movement of the counterweight box relative to the cross arm 30 can all adopt linear modules, as long as the linear movement can be realized.

Finally, it should be noted that the above embodiments are only used to describe the technical scheme of the present invention other than to limit it; although the present invention has been described in detail with reference to the above embodiments, those skilled in the art should understand that they can still modify the embodiments described in the above embodiments, or make equivalent substitutions of some or all of the technical features. However, these modifications or substitutions do not make the essence of the corresponding embodiments deviate from the embodiments of the present invention.

List of Reference Numbers in the Drawings
10 printer
20 upright post
30 cross arm
31 the first rack
32 the third rack
40 rotary mechanism
41 the first driving member
42 the first gear
43 the second gear
50 translational moving mechanism
51 mounting frame
52 the second driving member
53 the third gear
60 vertical arm
61 the second rack
62 the third driving member
63 the fourth gear
70 counterweight component
71 counterweight block
72 the fourth driving member
73 the fifth gear
80 fixed base.

What is claimed is:

1. A rotary mobile 3D printer, comprising:
a printer;
an upright post; and
a cross arm; wherein
the printer is connected to the cross arm;
the cross arm is rotatably connected to the upright post so that the cross arm is rotatable around the connection point where the cross arm is rotatably connected to the upright post;
the printer is rotatable together with the cross arm;
the printer is movable back and forth in a first direction and back and forth in a second direction relative to the cross arm;
the first direction is the lengthwise direction of the cross arm; and
the second direction extends at an angle with respect to the first direction.

2. The rotary mobile 3D printer according to claim 1, further comprising:
a rotary mechanism, wherein the rotary mechanism is connected between the upright post and the cross arm and the rotary mechanism drives the cross arm to rotate relative to the upright post.

3. The rotary mobile 3D printer according to claim 2, wherein
the rotary mechanism comprises a first driving member, a first gear and a second gear, and the first gear is mounted on the cross arm and the second gear is mounted on the upright post; and
the power output end of the first driving member is in driving connection with the first gear, the first gear meshes with the second gear, and the first gear is rotatable around the axis of the second gear, and the cross arm moves synchronously with the first gear.

4. The rotary mobile 3D printer according to claim 1, further comprising:
a translational moving mechanism, which is connected between the printer and the cross arm, and the translational moving mechanism drives the printer to move in the first direction.

5. The rotary mobile 3D printer according to claim 4, wherein
the cross arm is provided with a first rack with the length extending in the first direction;
the translational moving mechanism includes a second driving member, a third gear and a mounting bracket for connecting the printer;
the mounting bracket is slidably connected to the cross arm;
the second driving member is mounted on the mounting bracket;
the power output end of the second driving member is in driving connection with the third gear; and
the third gear meshes with the first rack.

6. The rotary mobile 3D printer according to claim 5, wherein
the cross arm is provided with a guide rail with its longitudinal dimension extending in the first direction;
the mounting bracket is provided with a clamping groove which is in clamping connection with the guide rail; and
the mounting bracket can slide back and forth in the lengthwise direction of the guide rail through the clamping groove.

7. The rotary mobile 3D printer according to claim 5, further comprising:
an upright arm, wherein the printer is mounted on the upright arm, the upright arm is slidably connected to the mounting frame and movable in the second direction, and the printer moves together with the upright arm to which it is mounted;
the upright arm is provided with a second rack with the length extending in the second direction; and
the rotary mobile 3D printer also comprises a third driving member and a fourth gear that is in driving connection with the power output end of the third driving member; wherein
the third driving member is installed on the mounting bracket; and
the fourth gear meshes with the second rack.

8. The rotary mobile 3D printer according to claim 1, further comprising:
a counterweight component; wherein
the counterweight component is installed on the cross arm and movable in the first direction relative to the cross arm; and
the column is located between the counterweight component and the printer.

9. The rotary mobile 3D printer according to claim 8, wherein
the cross arm is provided with a third rack with its longitudinal dimension extending in the first direction;
the counterweight component comprises a fourth driving member, a fifth gear and a counterweight block, wherein the counterweight block is slidably connected to the cross arm, and the fourth driving member is installed on the counterweight block;
the power output end of the fourth driving member is in driving connection with the fifth gear, and the fifth gear meshes with the third rack.

10. The rotary mobile 3D printer according to claim 1, further comprising:
a fixed base fixedly arranged on the upright post, wherein the fixed base is used for supporting the upright post.
